(19) United States
(12) Patent Application Publication
(10) Pub. No.: US 2025/0368535 A1
(43) Pub. Date: Dec. 4, 2025

(54) LITHIUM-RICH NICKEL-RICH POSITIVE ELECTRODE ACTIVE MATERIAL

(71) Applicants: Umicore, Brussels (BE); Centre National De La Recherche Scientifique, PARIS (FR); COLLEGE DE FRANCE, Paris (FR); SORBONNE UNIVERSITE, Paris (FR)

(72) Inventors: Maxime BLANGERO, Cheonan Chungcheongnam-do (KR); Pierre-Etienne CABELGUEN, Brussels (BE); Jean-Marie TARASCON, Paris (FR); Biao LI, Paris (FR)

(21) Appl. No.: 18/876,759

(22) PCT Filed: Jun. 20, 2023
(86) PCT No.: PCT/EP2023/066624

§ 371 Date: Dec. 19, 2024

(30) Foreign Application Priority Data
Jun. 21, 2022 (EP) 22290040.9
Jun. 21, 2022 (EP) 22290044.1

(51) Int. Cl. C01G 53/506

(52) U.S. Cl. CPC C01G 53/506; C01P 2002/72; C01P 2002/85; C01P 2002/86; C01P 2004/04; C01P 2006/40

(57) ABSTRACT

The present invention relates to Li-rich positive electrode active material comprising a layered structure and a disordered rock-salt structure exhibiting high capacity and excellent cycling stability.

### TECHNICAL FIELD AND BACKGROUND

This invention relates to a positive electrode active material comprising a layered structure and a disordered rock-salt structure, a method for manufacturing said positive electrode active material, use of said positive electrode active material in a battery, a battery comprising said positive electrode active material and a use of said battery.

The electric vehicles (EVs) market is under rapid growth, as witnessed by the number of electric vehicles on the roads that has set a new record of over 10 million at the end of 2020. The prosperity of the electric vehicles market is driving the demand for high-energy-density Li-ion batteries acting as the power sources. Throughout the past decades, enormous efforts have been devoted to exploring potential candidate materials of both cathodes and anodes in pursuit of high energy density for the batteries. Among them, the classical cathode candidates are primarily suffering from low capacities typically below 200 mAhg⁻¹ and, therefore, low energy densities, such as LiCoO₂, LiFePO₄, and LiNi_{1/3}Co_{1/3}Mn_{1/3}O₂. Hence, practical high-energy-density electrodes are pressingly demanded.

Ni-rich oxides are a class of materials which have received recently an increased interest due to their high capacities (>200 mAhg⁻¹) and high working potentials (˜3.8V). These compositions, derived from LiNiO₂, are typically LiNi_{ξ}Co_{ψ}Mn_{1-ξ-ψ}O₂ (so-called NMC) or LiNi_{ξ}Co_{ψ}Al_{1-ξ-ψ}O₂ (so called NCA), with ξ typically larger than 0.8. However, these Ni-rich electrodes are suffering from mechanical, electrochemical and thermal stability issues. Doping small amounts of high-valence transition metal ions such as molybdenum with these Ni-rich oxides can alleviate some of these problems (Park et al, Energy Environ. Sci., 2021, 14, 6616 or Susai et al, Materials 2021, 14, 2070), but this strategy does still not result in a positive electrode active material having excellent mechanical, structural and cycling stabilities necessary for high-energy-density electrodes.

It is an object of the present invention to provide a Li-rich positive electrode active material that exhibits high capacity and show excellent cycling stability.

It is a further object of the present invention to provide a method for manufacturing said positive electrode active material.

It is a further object of the present invention to provide a use of said positive electrode active material in a battery.

It is a further object of the present invention to provide a battery comprising said positive electrode material.

It is a further object of the present to provide a use of said battery in an electric vehicle.

### SUMMARY OF THE INVENTION

In a first aspect an object of the present invention is achieved by providing a positive electrode active material comprising a layered structure and a disordered rock-salt structure.

The present inventors surprisingly found that this Li-rich positive electrode active material doped with high-valence transition metal ions, such as Mo, exhibit high capacity and show excellent cycling stability, in particular compared to Li-poor (or non-Li-rich) positive electrode active material, as demonstrated in the appended examples. Moreover, the Li-rich positive electrode active material of the invention has an excellent mechanical reversibility and sustainability.

Without wishing to be bound by any theory, the present inventors believe that these higher capacity, better cycling stability and mechanical reversibility are achieved due to the Li-rich positive electrode active material of the invention comprising layered LiNiO₂ structure and Li₄MoO₅ disordered rock-salt structures intergrown together, as evidenced by XRD, TEM and NMR studies. The benefits of such intergrowth can be well manifested by the improved electrochemical performances, as with increasing Li and Mo content, the first-cycle Coulomb efficiency and the capacity increases. Moreover, the present inventors believe that the Li₄MoO₅ structure may act as structural support enabling better mechanical reversibility for the LiNiO₂ structure.

In a further aspect the invention provides a method for manufacturing said positive electrode active material.

In a further aspect the invention provides a use of said positive electrode active material.

In a further aspect the invention provides a battery comprising said positive electrode active material.

In a further aspect the invention provides a use of said battery in an electric vehicle.

### BRIEF DESCRIPTION OF THE FIGURES

FIG. 1: ⁷Li NMR spectra of the positive electrode active materials EX1, EX2, and EX3 manufactured by the process described in Example 1, Example 2, and Example 3, respectively.

FIG. 2: high angle annular dark field scanning transmission electron microscopy (HAADF-STEM) image of EX2.

FIG. 3: EDS mapping of EX2.

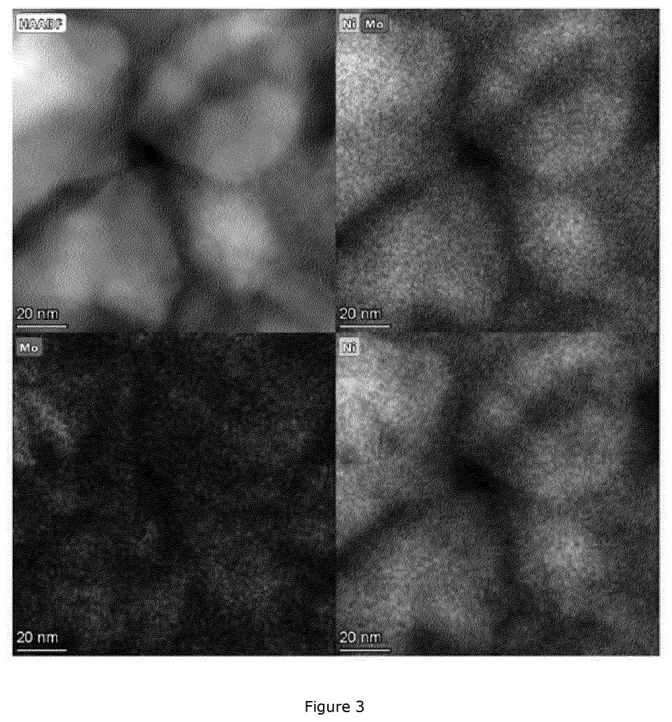

FIG. 4: (a-b) In situ XRD patterns for CEX1 and EX2, respectively. (c-d) XRD patterns (16-23°) at the end of charge in 2nd cycle (2C4.3V) for CEX1 and EX2, respectively.

FIG. 5: In situ XRD pattern (17-21°) for CEX1 and EX2, respectively, during the H2→H3 phase transition process. For each compound, left side shows the patterns evolution while correspondingly, the right side shows the contour plots.

FIG. 6: XRD images of EX1-3 and CEX1.

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

A positive electrode active material is defined as a material which is electrochemically active in a positive electrode. By active material, it must be understood a material capable to capture and release Li ions when subjected to a voltage change over a predetermined period of time.

In the framework of the present invention, at % signifies atomic percentage. The at % or “atomic percent” of a given element expression of a concentration means how many percent of all atoms in the concerned compound are atoms of said element. The designation at % is equivalent to mol % or “molar percent”.

### Positive Electrode Active Material

In a first aspect the invention provides a positive electrode active material comprising a layered structure and a disordered rock-salt structure.

In a preferred embodiment the positive electrode active material of the invention is represented by formula (I)

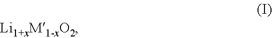

wherein x is in a range of 0<x<0.6.

A preferred embodiment is the positive electrode active material of the invention, wherein M′ is selected from the group consisting of Ni, Co, Mn, Q, M″ and a combination thereof, wherein Q is an element other than Li, O, Ni, Mo, Co, Mn and M″, preferably an element other than Li, O, Ni, Co, Mn and M″, and wherein M″ is selected from the group consisting of Ti, Zr, Hf, V, Nb, Ta, Cr, Mo, W, Te, Sb and a combination thereof. In certain preferred embodiments M′ is selected from the group consisting of Ni, Co, Mn, M″ and a combination thereof.

A certain preferred embodiment is the positive electrode active material according to formula (I), wherein Q is in a content e, wherein 0.0≤e≤2.0 mol %, relative to M′, preferably wherein 0.1≤e≤1.5 mol %, relative to M′; more preferably 0.2≤e≤1.0 mol %, relative to M′; most preferably 0.4≤e≤0.8 mol %, relative to M′. A highly preferred embodiment is the positive electrode active material according to the invention, wherein e=0.0 mol %.

A preferred embodiment is the positive electrode active material of the invention, wherein M′ comprises:
Ni in a content a, wherein 70.0≤a≤97.0 mol %, relative to M′;
M″ in a content b, relative to M′; and wherein b is in a range of 0<b≤20.0mol %;
Co in a content c, wherein 0.0≤c≤10.0 mol %, relative to M′;
Mn in a content d, wherein 0.0≤d≤10.0 mol %, relative to M′; and
Q in a content e, wherein 0.0≤e≤2.0 mol %, relative to M′;
wherein a, b, c, d, and e are measured by ICP-OES;
-wherein a+b+c+d+e is 100.0 mol %.

A preferred embodiment is the positive electrode active material according to the invention, wherein 0.01≤x≤0.4, preferably 0.02≤x≤0.2, most preferably 0.03≤x≤0.15. In certain embodiments the positive electrode active material is according to the invention, wherein 0.07≤x≤0.4, preferably 0.08≤x≤0.2, most preferably 0.09≤x≤0.15. A certain preferred embodiment is the positive electrode active material according to the invention, wherein x is in a range of 0.01≤x≤0.12, preferably 0.02≤x≤0.11, more preferably 0.03≤x≤0.10. A certain preferred embodiment is the positive electrode active material according to the invention, wherein x is in a range of 0.07≤x≤0.12, preferably 0.07≤x≤0.11, more preferably 0.07≤x≤0.10.

A preferred embodiment is the positive electrode active material according to the invention, wherein a is in a range of 75.0≤a≤96.0 mol %, relative to M′; more preferably 78.0≤a≤95.0 mol %, relative to M′; most preferably 80.0≤a≤94.0 mol %, relative to M′. In certain embodiments the positive electrode active material is according to the invention, wherein a is in a range of 75.0≤a≤90.0 mol %, relative to M′; more preferably 78.0≤a≤88.0 mol %, relative to M′; most preferably 80.0≤a≤86.0 mol %, relative to M′.

A preferred embodiment is the positive electrode active material according to the invention, wherein b is in a range of 1.0≤b≤15.0 mol %, preferably in a range of 2.0≤b≤12.5 mol %, most preferably in a range of 3.0≤b≤10.0 mol %. In certain embodiments the positive electrode active material is according to the invention, wherein 5.0≤b≤15.0 mol %, preferably in a range of 5.5≤b≤12.5 mol %, most preferably in a range of 6.0≤b≤10.0 mol %. 30

A preferred embodiment is the positive electrode active material according to the invention, wherein M″ is Cr, W, Mo or a combination thereof; preferably M″ is W, Mo or a combination thereof; most preferably M″ is Mo.

A preferred embodiment is the positive electrode active material according to the invention, wherein 0.1≤c≤9.0 mol %, relative to M′; preferably 1.0≤c≤8.0 mol %, relative to M′; most preferably 2.0≤c≤8.0 mol %, relative to M′. A highly preferred embodiment is the positive electrode active material according to the invention, wherein c=0.0 mol %.

A preferred embodiment is the positive electrode active material according to the invention, wherein 0.1≤d≤9.0 mol %, relative to M′; preferably 1.0≤d≤8.5 mol %, relative to M′; most preferably 2.0≤d≤8.0 mol %, relative to M′. A highly preferred embodiment is the positive electrode active material according to the invention, wherein d=0.0 mol %.

A preferred embodiment is the positive electrode active material according to the invention, wherein Q is selected from the group consisting of: Al, B, Ba, Ca, Fe, Mg, S, Si, Sr, Y, Zn and combinations thereof; preferably Al, B, S, Si, Y and combinations thereof.

A preferred embodiment is the positive electrode active material according to the invention, wherein 0.1≤e≤1.5 mol %, relative to M′; preferably 0.2≤e≤1.0 mol %, relative to M′; most preferably 0.4≤e≤0.8 mol %, relative to M′. A highly preferred embodiment is the positive electrode active material according to the invention, wherein e=0.0 mol %.

As appreciated by the skilled person the amount of a, b, c, d and e are measured by ICP-OES, in particular the amounts of Li, Ni, Co, Mn, Mo and W. For example, but not limited to this invention, a PerkinElmer NexION 2000 ICP mass spectrometer can be used for ICP-OES measurements.

A preferred embodiment is the positive electrode active material of the invention having a Li/M′ ratio z and M′ is an element other Li and O, wherein z>1, preferably≥1.01, more preferably z≥1.05, even more preferably z≥1.1, most preferably z≥1.2. A preferred embodiment is the positive electrode active material of the invention having a Li/M′ ratio z, wherein z<1.5, preferably z≤1.49, more preferably z≤1.45, even more preferably z≤1.4, most preferably z≤1.3. A preferred embodiment is the positive electrode active material of the invention having a Li/M′ ratio z, wherein 1<z<1.5, preferably 1.01≤z≤1.49, more preferably 1.05≤z≤1.45, even more preferably 1.1≤z≤1.4, most preferably 1.2≤z≤1.3. In certain preferred embodiments Li/M′ ratio z is 1.05≤z≤1.27, preferably 1.1≤z≤1.27, more preferably 1.2≤z≤1.27. In certain preferred embodiments Li/M′ ratio z is 1.05≤z≤1.22, preferably 1.1≤z≤1.22, more preferably 1.15≤z≤1.22.

As appreciated by the skilled person the Li/M′ ratio z is a molar ratio (mol/mol).

A more preferred embodiment is the positive electrode active material of the invention represented by formula (II)

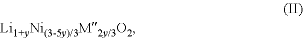

wherein 0<y≤0.6, relative to the total amount of Li, Ni and M″; preferably 0.01≤y≤0.4, relative to the total amount of Li, Ni and M″; more preferably 0.02≤y≤0.2, relative to the total amount of Li, Ni and M″. A certain preferred embodiment is the positive electrode active material according to the invention, wherein y is in a range of 0.01≤y≤0.12, relative to the total amount of Li, Ni and M″, preferably 0.02≤y≤0.11, relative to the total amount of Li, Ni and M″, more preferably 0.03≤y≤0.1 relative to the total amount of Li, Ni and M″. A certain preferred embodiment is the positive electrode active material according to the invention, wherein y is in a range of 0.07≤y≤0.12, relative to the total amount of Li, Ni and M″, preferably 0.07≤y≤0.11, relative to the total amount of Li, Ni and M″, more preferably 0.07≤y≤0.1, relative to the total amount of Li, Ni and M″.

A more preferred embodiment is the positive electrode active material of the invention represented by formula (II), wherein M″ is selected from the group consisting of Ti, Zr, Hf, V, Nb, Ta, Cr, Mo, W, Te, Sb and a combination thereof; preferably wherein M″ is Cr, W, Mo or a combination thereof; more preferably M″ is W, Mo or a combination thereof; most preferably M″ is Mo.

A highly preferred embodiment is the positive electrode active material of the invention represented by formula (II)a

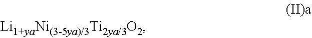

wherein 0<ya≤0.6, relative to the total amount of Li, Ni and Ti; preferably 0.01≤ya≤0.4, relative to the total amount of Li, Ni and Ti; more preferably 0.02≤ya≤0.2, relative to the total amount of Li, Ni and Ti. A certain preferred embodiment is the positive electrode active material according to the invention, wherein ya is in a range of 0.01≤ya≤0.12, relative to the total amount of Li, Ni and Ti, preferably 0.02≤ya≤0.11, relative to the total amount of Li, Ni and Ti, more preferably 0.03≤ya≤0.1, relative to the total amount of Li, Ni and Ti. A certain preferred embodiment is the positive electrode active material according to the invention, wherein ya is in a range of 0.07≤ya≤0.12, relative to the total amount of Li, Ni and Ti, preferably 0.07≤ya≤0.11, relative to the total amount of Li, Ni and Ti, more preferably 0.07≤ya≤0.1, relative to the total amount of Li, Ni and Ti.

A highly preferred embodiment is the positive electrode active material of the invention represented by formula (II)b

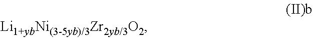

wherein 0<yb≤0.6, relative to the total amount of Li, Ni and Zr; preferably 0.01≤yb≤0.4, relative to the total amount of Li, Ni and Zr; more preferably 0.02≤yb≤0.2, relative to the total amount of Li, Ni and Zr. A certain preferred embodiment is the positive electrode active material according to the invention, wherein yb is in a range of 0.01≤yb≤0.12, relative to the total amount of Li, Ni and Zr, preferably 0.02≤yb≤0.11, relative to the total amount of Li, Ni and Zr, more preferably 0.03≤yb≤0.1, relative to the total amount of Li, Ni and Zr. A certain preferred embodiment is the positive electrode active material according to the invention, wherein yb is in a range of 0.07≤yb≤0.12, relative to the total amount of Li, Ni and Zr, preferably 0.07≤yb≤0.11, relative to the total amount of Li, Ni and Zr, more preferably 0.07≤yb≤0.1, relative to the total amount of Li, Ni and Zr.

A highly preferred embodiment is the positive electrode active material of the invention represented by formula (II)c

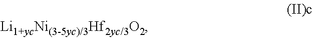

wherein 0<yc≤0.6, relative to the total amount of Li, Ni and Hf; preferably 0.01≤yc≤0.4, relative to the total amount of Li, Ni and Hf; more preferably 0.02≤yc≤0.2, relative to the total amount of Li, Ni and Hf. A certain preferred embodiment is the positive electrode active material according to the invention, wherein yc is in a range of 0.01≤yc≤0.12, relative to the total amount of Li, Ni and Hf, preferably 0.02≤yc≤0.11, relative to the total amount of Li, Ni and Hf, more preferably 0.03≤yc≤0.1, relative to the total amount of Li, Ni and Hf. A certain preferred embodiment is the positive electrode active material according to the invention, wherein yc is in a range of 0.07≤yc≤0.12, relative to the total amount of Li, Ni and Hf, preferably 0.07≤yc≤0.11, relative to the total amount of Li, Ni and Hf, more preferably 0.07≤yc≤0.1, relative to the total amount of Li, Ni and Hf.

A highly preferred embodiment is the positive electrode active material of the invention represented by formula (II)d

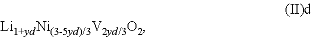

wherein 0<yd≤0.6, relative to the total amount of Li, Ni and V; preferably 0.01≤yd≤≤0.4, relative to the total amount of Li, Ni and V; more preferably 0.02≤yd≤0.2, relative to the total amount of Li, Ni and V. A certain preferred embodiment is the positive electrode active material according to the invention, wherein yd is in a range of 0.01≤yd≤0.12, relative to the total amount of Li, Ni and V, preferably 0.02≤yd≤0.11, relative to the total amount of Li, Ni and V, more preferably 0.03≤yd≤0.1, relative to the total amount of Li, Ni and V. A certain preferred embodiment is the positive electrode active material according to the invention, wherein yd is in a range of 0.07≤yd≤0.12, relative to the total amount of Li, Ni and Hf, preferably 0.07≤yd≤0.11, relative to the total amount of Li, Ni and Hf, more preferably 0.07≤yd≤0.1, relative to the total amount of Li, Ni and Hf.

A highly preferred embodiment is the positive electrode active material of the invention represented by formula (II)e

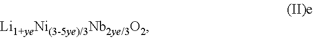

wherein 0<ye≤0.6, relative to the total amount of Li, Ni and Nb; preferably 0.01≤ye≤0.4, relative to the total amount of Li, Ni and Nb; more preferably 0.02≤ye≤0.2, relative to the total amount of Li, Ni and Nb. A certain preferred embodiment is the positive electrode active material according to the invention, wherein ye is in a range of 0.01≤ye≤0.12, relative to the total amount of Li, Ni and Nb, preferably 0.02≤ye≤0.11, relative to the total amount of Li, Ni and Nb, more preferably 0.03≤ye≤0.1, relative to the total amount of Li, Ni and Nb. A certain preferred embodiment is the positive electrode active material according to the invention, wherein ye is in a range of 0.07≤ye≤0.12, relative to the total amount of Li, Ni and Hf, preferably 0.07≤ye≤0.11, relative to the total amount of Li, Ni and Hf, more preferably 0.07≤ye≤0.1, relative to the total amount of Li, Ni and Hf.

A highly preferred embodiment is the positive electrode active material of the invention represented by formula (II)f

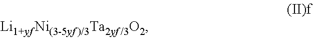

wherein 0<yf≤0.6, relative to the total amount of Li, Ni and Ta; preferably 0.01≤yf≤0.4, relative to the total amount of Li, Ni and Ta; more preferably 0.02≤yf≤0.2, relative to the total amount of Li, Ni and Ta. A certain preferred embodiment is the positive electrode active material according to the invention, wherein yf is in a range of 0.01≤yf≤0.12, relative to the total amount of Li, Ni and Ta, preferably 0.02≤yf≤0.11, relative to the total amount of Li, Ni and Ta, more preferably 0.03≤yf≤0.1, relative to the total amount of Li, Ni and Ta. A certain preferred embodiment is the positive electrode active material according to the invention, wherein yf is in a range of 0.07≤yf≤0.12, relative to the total amount of Li, Ni and Hf, preferably 0.07≤yf≤0.11, relative to the total amount of Li, Ni and Hf, more preferably 0.07≤yf≤ 0.1, relative to the total amount of Li, Ni and Hf.

A highly preferred embodiment is the positive electrode active material of the invention represented by formula (II)g

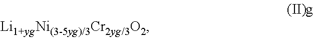

wherein 0<yg≤0.6, relative to the total amount of Li, Ni and Cr; preferably 0.01≤yg≤0.4, relative to the total amount of Li, Ni and Cr; more preferably 0.02≤yg≤0.2, relative to the total amount of Li, Ni and Cr. A certain preferred embodiment is the positive electrode active material according to the invention, wherein yg is in a range of 0.01≤yg≤0.12, relative to the total amount of Li, Ni and Cr, preferably 0.02≤yg≤0.11, relative to the total amount of Li, Ni and Cr, more preferably 0.03≤yg≤0.1, relative to the total amount of Li, Ni and Cr. A certain preferred embodiment is the positive electrode active material according to the invention, wherein yg is in a range of 0.07≤yg≤0.12, relative to the total amount of Li, Ni and Cr, preferably 0.07≤yg≤0.11, relative to the total amount of Li, Ni and Cr, more preferably 0.07≤yg≤0.1, relative to the total amount of Li, Ni and Cr.

A highly preferred embodiment is the positive electrode active material of the invention represented by formula (II)h

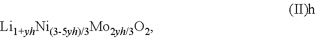

wherein 0<yh≤0.6, relative to the total amount of Li, Ni and Mo; preferably 0.01≤yh≤0.4, relative to the total amount of Li, Ni and Mo; more preferably 0.02≤yh≤0.2, relative to the total amount of Li, Ni and Mo. A certain preferred embodiment is the positive electrode active material according to the invention, wherein yh is in a range of 0.01≤yh≤0.12, relative to the total amount of Li, Ni and Mo, preferably 0.02≤yh≤0.11, relative to the total amount of Li, Ni and Mo, more preferably 0.03≤yh≤0.1, relative to the total amount of Li, Ni and Mo. A certain preferred embodiment is the positive electrode active material according to the invention, wherein yh is in a range of 0.07≤yh≤0.12, relative to the total amount of Li, Ni and Mo, preferably 0.07≤yh≤0.11, relative to the total amount of Li, Ni and Mo, more preferably 0.07≤yh≤0.1, relative to the total amount of Li, Ni and Mo.

A highly preferred embodiment is the positive electrode active material of the invention represented by formula (II)i

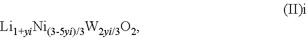

wherein 0<yi≤0.6, relative to the total amount of Li, Ni and W; preferably 0.01≤yi≤0.4, relative to the total amount of Li, Ni and W; more preferably 0.02≤yi≤0.2, relative to the total amount of Li, Ni and W. A certain preferred embodiment is the positive electrode active material according to the invention, wherein yi is in a range of 0.01≤yi≤0.12, relative to the total amount of Li, Ni and W, preferably 0.02≤yi≤0.11, relative to the total amount of Li, Ni and W, more preferably 0.03≤yi≤0.1, relative to the total amount of Li, Ni and W. A certain preferred embodiment is the positive electrode active material according to the invention, wherein yi is in a range of 0.07≤yi≤0.12, relative to the total amount of Li, Ni and W, preferably 0.07≤yi≤0.11, relative to the total amount of Li, Ni and W, more preferably 0.07≤yi≤0.1, relative to the total amount of Li, Ni and W.

A highly preferred embodiment is the positive electrode active material of the invention represented by formula (II)j

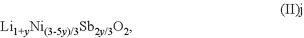

wherein 0<yj≤0.6, relative to the total amount of Li, Ni and Sb; preferably 0.01≤yj≤0.4, relative to the total amount of Li, Ni and Sb; more preferably 0.02≤yj≤0.2, relative to the total amount of Li, Ni and Sb. A certain preferred embodiment is the positive electrode active material according to the invention, wherein yj is in a range of 0.01≤yj≤0.12, relative to the total amount of Li, Ni and Sb, preferably 0.02≤yj≤0.11, relative to the total amount of Li, Ni and Sb, more preferably 0.03≤yj≤0.1, relative to the total amount of Li, Ni and Sb. A certain preferred embodiment is the positive electrode active material according to the invention, wherein yj is in a range of 0.07≤yj≤0.12, relative to the total amount of Li, Ni and W, preferably 0.07≤yj≤0.11, relative to the total amount of Li, Ni and W, more preferably 0.07≤yj≤0.1, relative to the total amount of Li, Ni and W.

A highly preferred embodiment is the positive electrode active material of the invention represented by formula (II)k

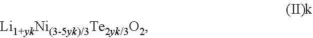

wherein 0<yk≤0.6, relative to the total amount of Li, Ni and Te; preferably 0.01≤yk≤0.4, relative to the total amount of Li, Ni and Te; more preferably 0.02≤yk≤0.2, relative to the total amount of Li, Ni and Te. A certain preferred embodiment is the positive electrode active material according to the invention, wherein yk is in a range of 0.01≤yk≤0.12, relative to the total amount of Li, Ni and Te, preferably 0.02≤yk≤0.11, relative to the total amount of Li, Ni and Te, more preferably 0.03≤yk≤0.1, relative to the total amount of Li, Ni and Te. A certain preferred embodiment is the positive electrode active material according to the invention, wherein yk is in a range of 0.07≤yk≤0.12, relative to the total amount of Li, Ni and Te, preferably 0.07≤yk≤0.11, relative to the total amount of Li, Ni and Te, more preferably 0.07≤yk≤0.1, relative to the total amount of Li, Ni and Te.

In certain preferred embodiments the positive electrode active material of the invention comprises a two-phase structure, as determined by transmission electron microscopy (TEM), preferably scanning transmission electron microscopy (STEM), more preferably high-angle annular dark-field scanning transmission electron microscopy (HAADF-STEM). For example, but not limited to the invention, the two-phase structure can be measured with a probe-corrected Titan Themis Z electron microscope operated at 200 kV and equipped with a Super-X EDX detector. Certain preferred embodiments is the positive electrode active material of the invention, wherein the two-phase structure comprises a layered structure and a disordered rock-salt structure. In a more preferred embodiment the two-phase structure consists of the layered structure and the disordered rock-salt structure.

In certain preferred embodiment is the positive electrode active material of the invention comprising a layered structure and a disordered rock-salt structure. In a more preferred embodiment the positive electrode active material consists of the layered structure and the disordered rock-salt structure.

A preferred embodiment is the positive electrode active material according to the invention, wherein the layered structure comprises Ni.

A preferred embodiment is the positive electrode active material according to the invention, wherein the disordered rock-salt structure comprises M″, wherein M″ is selected from the group consisting of Ti, Zr, Hf, V, Nb, Ta, Cr, Mo, W, Te, Sb and a combination thereof, preferably wherein M″ is Cr, W, Mo or a combination thereof;

more preferably wherein M″ is W, Mo or a combination thereof.

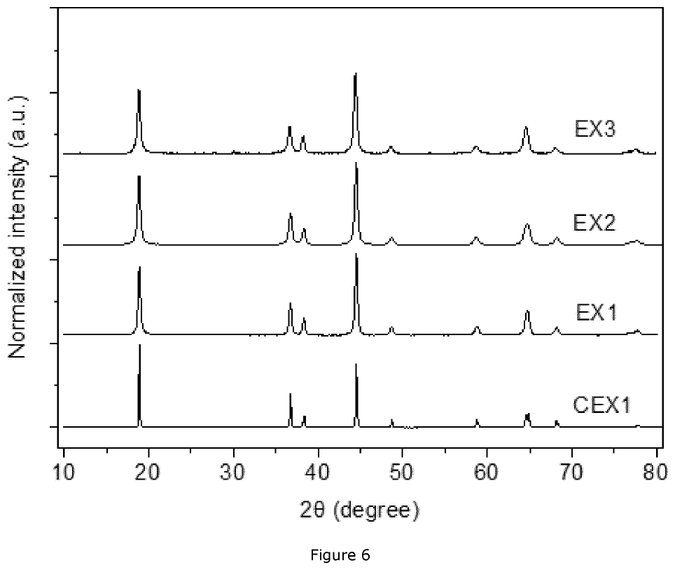

As appreciated by the skilled person the layered structure has a R3̅m symmetry, in particular the layered structure with R3̅m symmetry determined by X-ray diffraction having peaks around 2θ=17.5-20.0° and 2θ=43.5-45.5°. As appreciated by the skilled person the disordered rock-salt structure has a Fm3̅m symmetry, in particular the disordered rock-salt structure with Fm3̅m symmetry, determined by X-ray diffraction having peaks around 2θ=29.5-30.5° and 2θ=34.5-35.5°. As appreciated by the skilled person the positive electrode active material of the invention has a crystal structure which may also be empirically determined for example, by X-ray diffraction by observing peaks around at 2θ=17.5-20.0° and 2θ=43.5-45.5°. According to FIG. 6, there are peaks around 2θ=29.5-30.5° and 2θ=34.5-35.5° for the XRD pattern of EX3. It is demonstrated that, by increasing the amount of Mo which forms Li₄MoO₅, the two different types of crystal structure are observed by XRD analysis. With respect to the materials having the smaller amount of Mo, the crystal structures can be determined by analyzing not only XRD but also TEM and NMR.

In certain preferred embodiments said positive electrode active material comprises a two-phase structure, as determined by nuclear magnetic resonance (NMR), preferably ⁷Li NMR. A more preferred embodiment is the positive electrode active material of the invention, wherein the two-phase structure comprises a layered structure and a disordered rock-salt structure. In a more preferred embodiment the two-phase structure consists of the layered structure and the disordered rock-salt structure.

In certain highly preferred embodiments the layered structure comprises LiNiO₂ and the disordered rock-salt structure comprises Li₄M¹O₅, wherein M¹ is selected from the group consisting of Cr, Mo, W, Te and a combination thereof; preferably wherein M¹ is Cr, W, Mo or a combination thereof; more preferably M¹ is W, Mo or a combination thereof. In highly preferred embodiments the disordered rock-salt structure comprises Li₄MoO₅. In certain highly preferred embodiments the layered structure comprises LiNiO₂ and the disordered rock-salt structure comprises Li₃M²O₄, wherein M² is selected from the group consisting of V, Nb, Ta, Sb and a combination thereof; preferably wherein M² is V, Nb, Ta, Sb and a combination thereof; more preferably M² is V, Nb or Ta. In certain highly preferred embodiments the layered structure comprises LiNiO₂ and the disordered rock-salt structure comprises Li₂M³O₃, wherein M³ is selected from the group consisting of Ti, Zr, Hf, Te and a combination thereof; preferably wherein M³ is Ti, Zr, Hf or a combination thereof; more preferably M³ is Ti, Zr or Hf.

In certain highly preferred embodiments the layered structure consists of LiNiO₂ and the disordered rock-salt structure consists of Li₄M¹O₅, wherein M¹ is selected from the group consisting of Cr, Mo, W, Te and a combination thereof; preferably wherein M¹ is Cr, W, Mo or a combination thereof; more preferably M¹ is W, Mo or a combination thereof. In certain highly preferred embodiments the layered structure consists of LiNiO₂ and the disordered rock-salt structure consists of Li₃M²O₄, wherein M² is selected from the group consisting of V, Nb, Ta, Sb and a combination thereof; preferably wherein M² is V, Nb, Ta, Sb and a combination thereof; more preferably M² is V, Nb or Ta. In certain highly preferred embodiments the layered structure consists of LiNiO₂ and the disordered rock-salt structure consists of Li₂M³O₃, wherein M³ is selected from the group consisting of Ti, Zr, Hf, Te and a combination thereof; preferably wherein M³ is Ti, Zr, Hf or a combination thereof; more preferably M³ is Ti, Zr or Hf.

In highly preferred embodiments the disordered rock-salt consists of Li₄MoO₅. As appreciated by the skilled person the ⁷Li signal of the layered structure is determined between 600 and 750 ppm, preferably between 650 and 725 ppm, more preferably between 665 and 685 ppm, most preferably about 680 ppm. As appreciated by the skilled person the ⁷Li signal of the disordered rock-salt structure is determined between −100 and 100 ppm, preferably between −50 and 50 ppm, more preferably between −5 and 5 ppm, most preferably about 0 ppm.

In a more preferred embodiment the layered structure comprises less than 70.0 mol % ⁷Li, relative to the total amount of ⁷Li of the positive electrode active material; preferably less than 60.0 mol % ⁷Li, relative to the total amount of ⁷Li of the positive electrode active material; most preferably less than 50.0 mol % ⁷Li, relative to the total amount of ⁷Li of the positive electrode active material; as determined via NMR. In a more preferred embodiment the layered structure comprises more than 20.0 mol % ⁷Li, relative to the total amount of ⁷Li of the positive electrode active material; preferably more than 30.0 mol % ⁷Li, relative to the total amount of ⁷Li of the positive electrode active material; most preferably more than 40.0 mol % ⁷Li, relative to the total amount of ⁷Li of the positive electrode active material; as determined via NMR. In a more preferred embodiment the layered structure comprises between 20.0 and 70.0 mol % ⁷Li, relative to the total amount of Li of the positive electrode active material; preferably between 30.0 and 60.0 mol % ⁷Li, relative to the total amount of ⁷Li of the positive electrode active material; most preferably between 40.0 and 50.0 mol % ⁷Li, relative to the total amount of ⁷Li of the positive electrode active material; as determined via NMR.

In a more preferred embodiment the disordered rock-salt structure comprises less than 50.0 mol % ⁷Li, relative to the total amount of ⁷Li of the positive electrode active material; preferably less than 40.0 mol % ⁷Li, relative to the total amount of ⁷Li of the positive electrode active material; most preferably less than 30.0 mol % ⁷Li, relative to the total amount of ⁷Li of the positive electrode active material; as determined via NMR. In a more preferred embodiment the disordered rock-salt structure comprises more than 5.0 mol % ⁷Li, relative to the total amount of ⁷Li of the positive electrode active material; preferably more than 8.0 mol % ⁷Li, relative to the total amount of ⁷Li of the positive electrode active material; most preferably more than 10.0 mol % ⁷Li, relative to the total amount of ⁷Li of the positive electrode active material; as determined via NMR. In a more preferred embodiment the disordered rock-salt structure comprises between 5.0 and 50.0 mol % ⁷Li, relative to the total amount of Li of the positive electrode active material; preferably between 8.0 and 40.0 mol % ⁷Li, relative to the total amount of ⁷Li of the positive electrode active material; most preferably between 10.0 and 30.0 mol % ⁷Li, relative to the total amount of ⁷Li of the positive electrode active material; as determined via NMR.

As appreciated by the skilled person the relative weight of each contribution of layered structure or disordered rock salt was obtained from the area of the whole spinning sideband pattern. For example, but not limiting to the invention, the two-phase structure and/or the layered structure and/or the disordered rock-salt structure can be measured with a 4.7 T Avance III HD Bruker NMR spectrometer (77.8 MHz for ⁷Li), using a 1.3 mm magic angle spinning (MAS) probe spinning at 62.5 kHz under pure nitrogen gas.

As appreciated by the skilled person the two-phase structure as determined by NMR is the same two-phase structure as determine by TEM. In particular, the layered structure as determined by NMR is the same layered structure as determined by TEM and the disordered rock-salt structure as determined by NMR is the same disordered rock-salt structure as determined by TEM.

In certain preferred embodiments the positive electrode active material comprises an interphase structure, preferably an interphase structure between the layered structure and the disordered rock-salt structure, as determined via NMR, preferably ⁷Li NMR. Said interphase structure comprises, preferably consists of, of Ni-rich rock salt phase. In more preferred embodiments said interphase structure has a ⁷Li signal between 300 and 600 ppm, preferably between 350 and 550 ppm, most preferably between 400 and 500 ppm.

In a more preferred embodiment the positive electrode active material of the invention has a lattice parameter a, wherein a≥2.8810, preferably a≥2.8815, more preferably a≥2.8820, wherein the lattice parameter a is determined via Rietveld refinement. In a more preferred embodiment the positive electrode active material of the invention has a lattice parameter a, wherein a≤2.8860, preferably a≤2.8865, more preferably a≤2.8870, wherein the lattice parameter a is determined via Rietveld refinement. In a more preferred embodiment the positive electrode active material of the invention has a lattice parameter a, wherein 2.8810≤a≤2.8870, preferably 2.8815≤a≤2.8865, more preferably 2.8820≤a≤2.8860, wherein the lattice parameter a is determined via Rietveld refinement.

In a more preferred embodiment the positive electrode active material of the invention has a lattice parameter c, wherein c≥14.200, preferably c≥14.210, more preferably c≥14.220, wherein the lattice parameter c is determined via Rietveld refinement. In a more preferred embodiment the positive electrode active material of the invention has a lattice parameter c, wherein c≤14.235, preferably c≤14.230, more preferably c≤14.225, wherein the lattice parameter c is determined via Rietveld refinement. In a more preferred embodiment the positive electrode active material of the invention has a lattice parameter c, wherein 14.200≤c≤14.235, preferably 14.210≤c≤14.230, more preferably 14.220≤c≤14.225, wherein the lattice parameter c is determined via Rietveld refinement.

In a more preferred embodiment the positive electrode active material of the invention has a ratio of lattice parameters c/a≤4.930, preferably c/a≤4.929, more preferably c/a≤4.928 wherein the lattice parameter a and the lattice parameter c are determined via Rietveld refinement.

In a more preferred embodiment the positive electrode active material of the invention has a particle size of less than 500 nm, preferably less than 400 nm, more preferably less than 300 nm, wherein the particle size is determined via SEM.

In a second aspect the invention provides a positive electrode active material represented by formula (I)

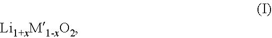

wherein x is in a range of 0<x<0.6.

As appreciated by the skilled person all embodiments related to the positive electrode material according to the first aspect of the invention equally apply to the positive electrode according to the second aspect of the invention.

### Method for Manufacturing

In a third aspect the invention provides a method for manufacturing a positive electrode active material, wherein said method comprises the consecutive steps of:
Step 1) dissolving salts of M′ with stoichiometric molar ratio into an alcohol or water and stirring while heating to obtain a mixture, wherein M′ comprises Ni and M″ and wherein M″ is selected from the group consisting of Ti, Zr, Hf, V, Nb, Ta, Cr, Mo, W, Te, Sb and a combination thereof;
Step 2) drying said mixture at a temperature in a range of 100 to 150° C.; and
Step 3) heating the dried material at a temperature in a range of 700 to 800° C.

As appreciated by the skilled person all embodiments related to the positive electrode active material according to the first aspect of the invention and the positive electrode active material according to the second aspect of the invention equally apply to the method for manufacturing a positive electrode active material of the invention.

In a preferred embodiment of the method, during said dissolving salts of M′ a lithium source is also dissolved into ethanol or water, preferably the lithium source is lithium acetate and/or lithium acetate dihydrate.

In a preferred embodiment of the method, the salts of M′ comprise a salt of nickel and a salt of M″, wherein M″ is selected from the group consisting of Ti, Zr, Hf, V, Nb, Ta, Cr, Mo, W, Te, Sb and a combination thereof, preferably M″ is Cr, W, Mo or a combination thereof, preferably M″ is W, Mo or a combination thereof, most preferably M″ is Mo. In certain preferred embodiments the salt of nickel is nickel (II) acetate and/or nickel (II) acetate dihydrate and the salt of M″ is (NH₄)₆Mo₇O₂₄·4H₂O.

In a preferred embodiment of the method, the alcohol is methanol, ethanol, propanol, butanol or a combination thereof; preferably ethanol, propanol or a combination thereof; most preferably ethanol.

In a preferred embodiment of the method, the salts of M′ are dissolved homogenously in the alcohol or the water.

A preferred embodiment is the method, wherein the heating temperature of Step 1) while stirring is in a range of 50° C. to 150° C., preferably in a range of 75° C. to 125° C., most preferably in a range of 80° C. to 100° C.

A preferred embodiment is the method, wherein the drying said mixture of step 2) occurs in air, preferably in dry air.

A preferred embodiment is the method, wherein drying said mixture of step 2) at a temperature in a range of 100° C. to 150° C., preferably in a range of 110° C. to 140° C., more preferably in a range of 115° C. to 135° C.

A preferred embodiment is the method, wherein the heating the dried material of step 3) is in a range of 700° C. to 800° C., preferably in a range of 710° C. to 790° C., most preferably in a range of 725° C. to 775° C.

A preferred embodiment is the method, wherein the heating said dried material of step 3) occurs under an atmosphere comprising oxygen, preferably an atmosphere consisting of oxygen.

In a highly preferred embodiment of the invention the method for manufacturing a positive electrode active material is the positive electrode active material according to the first aspect of the invention and/or the positive electrode active material according to the second aspect of the invention.

In a fourth aspect the invention provides a method for manufacturing a positive electrode active material, wherein said positive electrode active material has a chemical formula as Li₁₊ₓM′₁₋ₓO₂, wherein x is in a range of 0<x<0.6, wherein M′ comprises Ni and Mo, and wherein said method comprises the consecutive steps of:
Step 1) dissolving salts of M′ with stoichiometric molar ratio into an alcohol or water and stirring while heating to obtain a mixture,
Step 2) drying said mixture at a temperature in a range of 100° C. to 150° C., and
Step 3) heating the dried material at a temperature in a range of 700° C. to 800° C.

As appreciated by the skilled person all embodiments related to the positive electrode active material according to the first aspect of the invention, the positive electrode active material according to the second aspect of the invention and the method for manufacturing a positive electrode active material according to the third aspect of the invention equally apply to the method for manufacturing the positive electrode active material according to the fourth aspect of the invention.

In a highly preferred embodiment of the invention the method for manufacturing a positive electrode active material is the positive electrode active material according to the first aspect of the invention and/or the positive electrode active material according to the second aspect of the invention.

### Battery

In a fifth aspect the invention provides a battery comprising the positive electrode active material of the invention, in particular the positive electrode active material according to the first aspect of the invention and/or the positive electrode active material according to the second aspect of the invention.

In a preferred embodiment of the invention, the battery has a DQ1 higher than 190 mAhg⁻¹, preferably a DQ1 higher than 200 mAhg⁻¹, more preferably a DQ1 higher than 210 mAhg⁻¹. As appreciated by the skilled person DQ1 is the first discharge capacity of the battery.

In a preferred embodiment of the invention, the battery has a relative capacity higher than 65%, preferably higher than 70%, more preferably higher than 75%, even more preferably higher than 80%, even more preferably higher than 85%, most preferably higher than 85%. As appreciated by the skilled person relative capacity is defined as

$$Relative capacity ( \% ) = \frac{DQ 101}{DQ 1} \times 100 ( \% ) ,$$

wherein DQ1 is the first discharge capacity of the battery and DQ101 is the final discharge capacity after 100 cycles.

As demonstrated in the appended examples the battery of the invention has no bulk fatigue, meaning that during cycling, in particular already after 2 cycles, the battery remains electrochemically stable. A battery comprising LiNiO₂ as positive electrode active material exhibits this bulk fatigue due to the formation of surface disordered rock-salt phase that causes mechanical failure. This is characteristic of some inactive Li ions that are not electrochemically accessible, hence the fading of the capacity. In situ XRD patterns for LiNiO₂ a pattern of charged LiNiO₂ showing the co-existence of Li-rich and Li-poor phases due to bulk fatigue, whereas the pattern of the charged positive electrode active material according to the first aspect of the invention and/or the positive electrode active material according to the second aspect of the invention only shows a single-phase.

### Use

In a sixth aspect the present invention provides a use of the positive electrode active material according to the first aspect of the invention and/or according to the second aspect of the invention in a battery.

A preferred embodiment is the use of the positive electrode active material in a battery to increase first discharge capacity of the battery, to increase the relative capacity of the battery and/or to increase the electrochemical stability of the battery.

In a seventh aspect the present invention provides a use of the battery according to invention in either one of a portable computer, a tablet, a mobile phone, an energy storage system, an electric vehicle or in a hybrid electric vehicle, preferably in an electric vehicle or in a hybrid electric vehicle.

### Examples

### Description of Testing Methods

### ICP-OES Analysis

The amount of Li, Ni, Mo, W, Mn, and Co in the positive electrode active material powder was measured with the Inductively Coupled Plasma (ICP) method by using a PerkinElmer NexION 2000 ICP mass spectrometer. 0.5 mg of a powder sample was dissolved into 1 mL aqua regia in a 100 mL volumetric flask. Afterwards, the volumetric flask was filled with distilled water up to the 100 mL mark, followed by complete homogenization for dilution. The diluted solution was used for ICP-OES measurement. The Ni, Mo, W, Mn, and Co and Q contents (a, b, c, d, and e contents, respectively) measured are expressed as mol % of the total of these contents.

### Transmission Electron Microscopy (TEM) and Energy Dispersive X-Ray Spectroscopy (EDS) Analysis

The electron microscopic images were measured with the Transmission Electron Microscopy (TEM) and Energy Dispersive X-ray Spectroscopy (EDS). The positive electrode active material powder was ground in an agate mortar in dimethyl carbonate and deposited drops of suspension onto copper TEM grid with holey carbon support layer, which was prepared in an Ar-filled glove box. The sample was transported to the TEM column by means of a Gatan vacuum transfer holder completely avoiding contact with air and moisture. Electron diffraction (ED) patterns, high angle annular dark field scanning transmission electron microscopy (HAADF-STEM) images and energy-dispersive X-ray spectra (EDS) were collected with a probe-corrected Titan Themis Z electron microscope operated at 200 kV and equipped with a Super-X EDX detector.

### ⁷Li Nuclear Magnetic Resonance (NMR) Analysis

A solid-state NMR was measured to observe the chemical structure of the prepared material using a 4.7 T Avance III HD Bruker NMR spectrometer (77.8 MHz for ⁷Li), using a 1.3 mm magic angle spinning (MAS) probe spinning at 62.5 kHz under pure nitrogen gas. Without temperature regulation, the temperature inside the rotor is expected to be around 50° C. All ⁷Li NMR experiments were recorded with a rotor-synchronized Hahn echo sequence, and the 90° pulse was set to 1.1 μs and the chemical shift was referenced with liquid ⁷LiCl in water at 0 ppm (corresponding to a 227 kHz B1 field strength). The T1 relaxation times were measured using a saturation-recovery experiment, using 20×90° pulses separated by a 1 ms delay for saturation. The T1 behavior was found to be mono-exponential for the left hand side peaks (around 600-850 ppm) and the T1 values were around 2-5 ms, as expected for ⁷Li spins close to paramagnetic Ni³⁺ ions. For the diamagnetic part, the T1 relaxation was found to be multiexponential, with at least two components, a slow relaxing component with T1 values between 1 and 1.5 s, while a fast relaxing component was observed with T1 values between 5 and 30 ms. This is expected as, first, the spinning sideband from the LiNiO₂ peak is close to the 0 ppm contribution (fitted in red, on the right hand side, around −120 ppm); second, the diamagnetic contribution is made of lithium in molybdenum rich domains, embedded in the LiNiO₂ phase, and therefore, lithium ions close to the interface will display shorter relaxation times. Therefore, all ⁷Li spectra were recorded using a 5 to 10 s relaxation delays to ensure a proper quantification of the diamagnetic contribution, with at least 1024 transients recorded to ensure a sufficient signal-to-noise ratio. The spectra were deconvoluted with DMFit, using the minimum number of necessary Gaussian-Lorentzian spinning sideband patterns (5 spinning sidebands maximum) characterized by a Gaussian/Lorentzian ratio, a position (in ppm), a width (in ppm), and an intensity, all of which were fitted by the program. The spinning sidebands intensities were fitted independently, and the relative weight of each contribution was obtained from the area of the whole spinning sideband pattern. Preferably, special care was taken to measure NMR spectra on fresh samples with as little contact as possible with residual moisture in the glovebox or in the NMR spectrometer.

### X-Ray Diffraction (XRD) Analysis

XRD patterns were obtained via a lab X-ray diffractometer (BRUKER D8 Advance) equipped with Cu Kα radiation source (λ_{Kα1}=1.54056 Å, λ_{Kα2}=1.54439 Å) and a Lynxeye XE detector. A homemade airtight cell with a Be window was used for in situ XRD experiments, for which the electrochemistry was ran synchronously with data acquisition. All the Rietveld refinements of the XRD patterns were done with the FullProf program

### Scanning Electron Microscopy (SEM) Analysis

SEM images were obtained on an FEI Magellan scanning electron microscope equipped with an Oxford Instruments energy dispersive X-ray spectroscopy (EDX) detector. EDX was carried out using an acceleration voltage of 20 kV.

### Electrochemical Test

The positive electrode for the electrochemical test comprised 70 wt. % positive electrode active material, 20 wt. % carbon (Super P) and 10 wt. % PTFE. An OEMS cell was used for the electrochemical test. 150 μL of LP57+2% VC electrolyte, Li foil as anode and 1 piece of GF/D glass fiber separator were used to construct the half cell. The quantitative gas evolution data on m/z channels of 32 (O₂) and 44 (CO₂) was were collected in operando with a protocol of resting the cell for 4 h before and 12 h after the full electrochemistry to stabilize the background signal. The electrochemical cell was cycled between 2.0-4.3 V for 101 cycles at C/10 (20 mA/g) rate at room temperature.

The initial discharge capacity (DQ1) and the final discharge capacity (DQ101) after 100 cycles are measured and the ratio of DQ1 and DQ101 is calculated to compare the electrochemical stability of the electrodes comprising the materials manufactured from Examples and Comparative Examples. The relative capacity (%) is expressed in % as:

$$Relative capacity ( \% ) = \frac{DQ 101}{DQ 1} \times 100 ( \% )$$

### EXAMPLES

### Example 1 (EX1)

A Positive Electrode Active Material is Obtained through Following Steps:
1) Preparing a mixed metal solution: 2.2707 grams of Li (CH₃COO)·2H₂O and 4.4791 grams of Ni(CH₃COO)₂·4H₂O are dissolved homogeneously in 80 mL ethanol (>98%). 0.1412 grams of (NH₄)6Mo₇O₂₄·4H₂O is dissolved homogeneously in 20 mL distilled water. The aqueous solution containing ammonium heptamolybdate is added into the acetate ethanol solution containing lithium ion and nickel ion so as to obtain a mixed metal solution.
2) Preparing a gel-type mixture: The mixed metal solution obtained from Step 1) is stirred and heated at the same time at 80° C. so as to obtain a gel-type mixture.
3) Drying and grinding: The gel-type mixture obtained from Step 2) is dried at 120° C. under oxygen flow for 8 hours and the dried material was ground.
4) Heating: The ground material is heated at 750° C. under oxygen flow for 8 hours so as to obtain EX1.

### Example 2 (EX2)

A positive electrode active material EX2 is obtained through the same process as Example 1 except that 2.3350 grams of Li(CH₃COO)·2H₂O, 4.2303 grams of Ni(CH₃COO)₂·4H₂O, and 0.2119 grams of (NH₄)6Mo₇O₂₄·4H₂O are used to prepare a mixed metal solution in Step 1).

### Example 3 (EX3)

A positive electrode active material EX3 is obtained through the same process as Example 1 except that 2.3993 grams of Li(CH₃COO)·2H₂O, 3.9814 grams of Ni(CH₃COO)₂·4H₂O, and 0.2825 grams of (NH₄)6Mo₇O₂₄·4H₂O are used to prepare a mixed metal solution in Step 1).

### Comparative Example 1 (CEX1)

A Positive Electrode Active Material CEX1 is Obtained through Following Steps:
1) Preparing a mixed metal solution: 2.1422 grams of Li(CH₃COO)·2H₂O and 4.9768 grams of Ni(CH₃COO)₂·4H₂O are dissolved homogeneously in 80 mL ethanol (>98%) so as to obtain a mixed metal solution.
2) Preparing a gel-type mixture: The mixed metal solution obtained from Step 1) is stirred and heated at the same time at 80° C. so as to obtain a gel-type mixture.
3) Drying and grinding: The gel-type mixture obtained from Step 2) is dried at 120° C. under oxygen flow for 8 hours and the dried material was ground.
4) Heating: The ground material is heated at 750° C. under oxygen flow for 8 hours so as to obtain CEX1.

### Comparative Example 2 (CEX2)

A positive electrode active material CEX2 is obtained through the same process as Example 1 except that 2.1422 grams of Li(CH₃COO)·2H₂O, 4.6782 grams of Ni(CH₃COO)₂·4H₂O, and 0.2119 grams of (NH₄)6Mo₇O₂₄·4H₂0 are used to prepare a mixed metal solution in Step 1).

### Comparative Example 3 (CEX3)

A positive electrode active material CEX3 is obtained through the same process as Example 1 except that 2.1422 grams of Li(CH₃COO)·2H₂O, 4.5787 grams of Ni(CH₃COO)₂·4H₂O, and 0.2825 grams of (NH₄)6Mo₇O₂₄·4H₂O are used to prepare a mixed metal solution in Step 1).

The molar contents of components for EX1, EX2, EX3, CEX1, CEX2, and CEX3 were analyzed by ICP-OES and summarized in Table 1. Also, the results of the electrochemical tests used on the examples are summarized in Table 1.

TABLE 1
Summary of the molar contents of components for examples and comparative examples
analyzed by ICP-OES and the electrochemical results used on the examples.

| | Molar contents of | | | Electrochemical results | |
|---|---|---|---|---|---|
| | components (M'= Ni + Mo) | | | | Relative |
| Example | Li/M′ | Ni | Mo | DQ1 | capacity |
| ID | (mol/mol) | (at % vs. M′) | (at % vs. M′) | (mAh/g) | (%) |
| EX1 | 1.13 | 95.7 | 4.3 | 213.0 | 71.8 |
| EX2 | 1.20 | 93.4 | 6.6 | 223.0 | 90.2 |
| EX3 | 1.27 | 90.9 | 9.1 | 226.0 | 76.3 |
| CEX1 | 1.00 | 100.0 | 0.0 | 222.0 | 63.5 |
| CEX2 | 1.00 | 94.0 | 6.0 | 174.7 | 88.3^{a} |
| CEX3 | 1.00 | 92.0 | 8.0 | 173.9 | 92.5^{a} |

^{a}relative capacity determined after 50 cycles

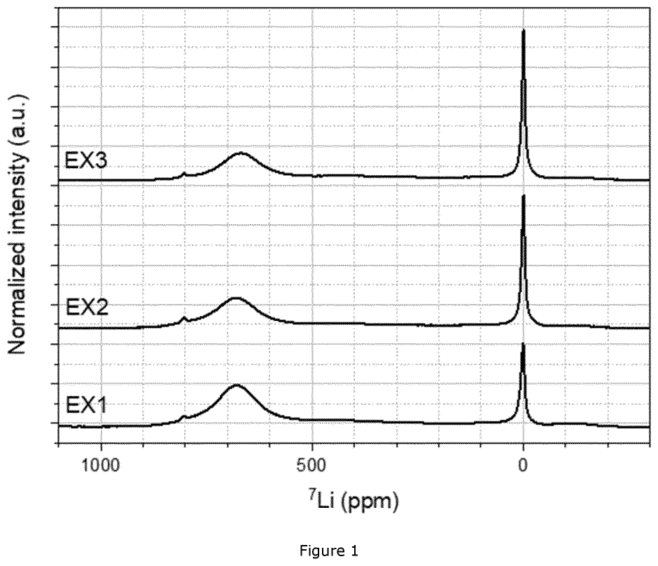

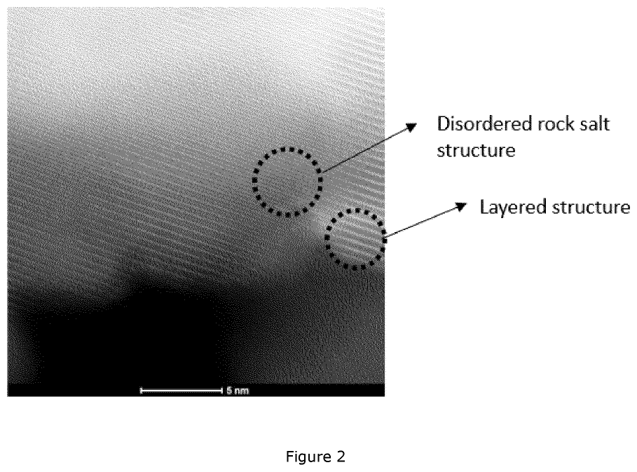

By analyzing the ICP-OES results, it was demonstrated that the positive electrode active materials EX1, EX2, and EX3 prepared through Examples 1, 2, and 3, respectively, were well synthesized as Li-rich materials. From the observation of HAADF-STEM images, the positive electrode active material EX1, EX2, and EX3 comprise two types of structure which are a layered structure and a disordered structure. FIG. 2 is a HAADF-STEM image of EX2 as a representative for the two-phase structure of the materials EX1, EX2, and EX3. Mo and Ni were distributed with inhomogeneity by observing the TEM-EDS mapped images, which suggests that there are two types of domain such as a LiNiO₂-rich domain and a Li₄MoO₅-rich domain. To confirm the two-phase intergrown structure, ⁷Li NMR spectra was analyzed that there were a peak shifted at near 0 ppm indicating LiNiO₂-rich domain and a peak shifted at around 680 ppm indicating Li₄MoO₅-rich domain. By increasing the amount of Mo, the peak around 0 ppm was getting higher as described in FIG. 1.

Table 2 shows the lattice parameters a and c of EX1-3 and CEX1 as determined via Rietveld refinement.

TABLE 2
lattice parameters a and c of EX1-3 and CEX1
as determined via Rietveld refinement.

| | Lattice | | |
|---|---|---|---|
| Example ID | parameter a | Lattice parameter c | Lattice parameter c/a |
| EX1 | 2.8820 | 14.2046 | 4.9286 |
| EX2 | 2.8844 | 14.2126 | 4.9274 |
| EX3 | 2.8864 | 14.2240 | 4.9280 |
| CEX1 | 2.8809 | 14.2064 | 4.9313 |

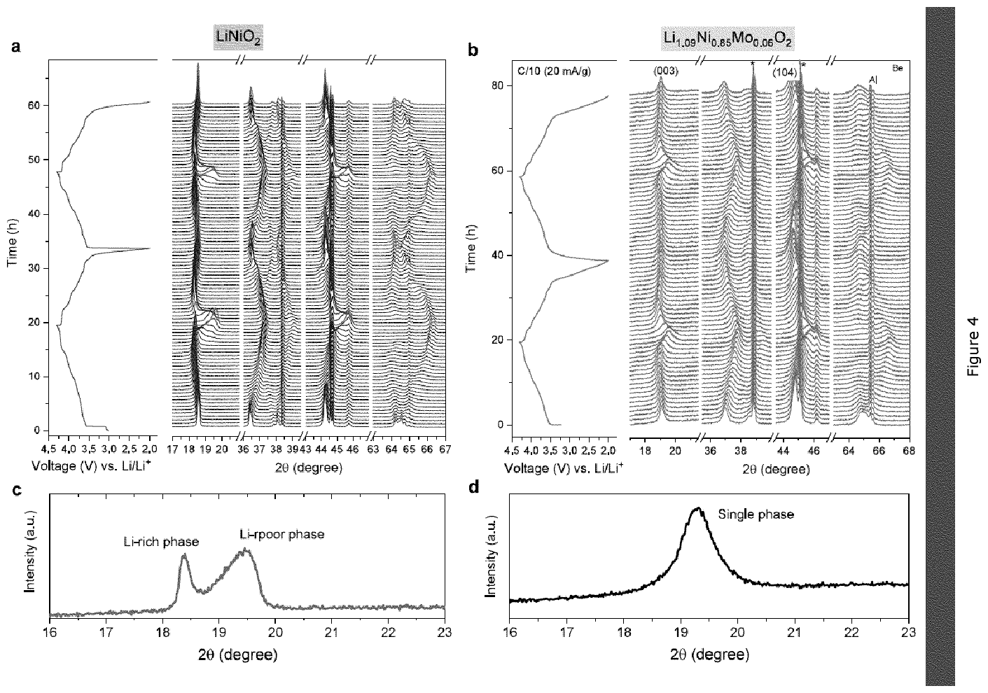

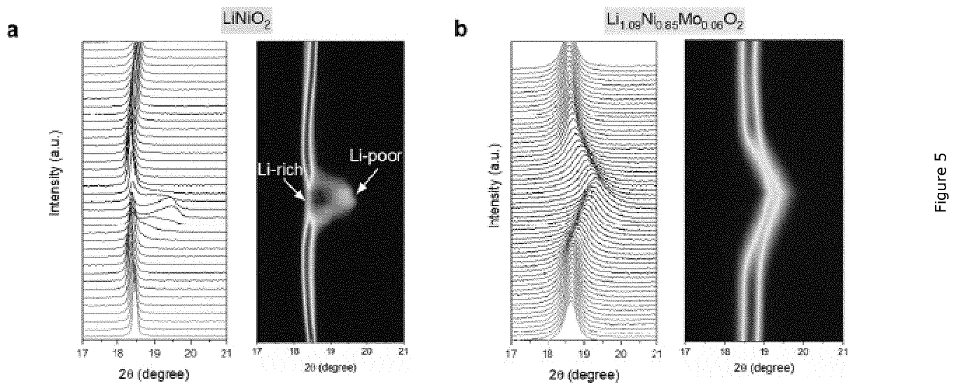

FIG. 4 shows the comparison of the in situ XRD evolution between CEX1 and EX2. The pattern of charged CEX1 shows a bifurcation of (003) peak with the co-existence of Li-rich and Li-poor phases due to bulk fatigue, whereas the pattern of charged EX2 only shows a single-phase. FIG. 5 shows in situ XRD patterns (16-23°) for CEX1 and EX2 at the end of charge in 2nd cycle (2C4.3V) for CEX1 and EX2, respectively. The pattern of charged LiNiO₂ shows a bifurcated peak with the co-existence of Li-rich and Li-poor phases due to bulk fatigue, whereas the pattern of charged Li_{1.09}Ni_{0.85}Mo_{0.06}O₂ only shows a single-phase.

Table 3 shows the quantification of the different phases of LiNiO₂ and Li₄MoO₅ as determined via ⁷Li NMR.

TABLE 3
chemical shift and quantification of ⁷Li NMR of EX1-3 and CEX1.

| Example ID | Peak | Shift (ppm) | Area (%) |
|---|---|---|---|
| EX1 | LiNiO₂ | 680 | 49.7 |
| | Li₄MoO₅ | 4 | 12.6 |
| EX2 | LiNiO₂ | 681 | 45.2 |
| | Li₄MoO₅ | 7 | 21.1 |
| EX3 | LiNiO₂ | 670 | 47.0 |
| | Li₄MoO₅ | 1 | 24.1 |
| CEX1 | LiNiO₂ | 681 | 75.8 |
| | Li₄MoO₅ | 0 | 7.9 |

FIG. 6 depicts the XRD patters of EX1-3 and CEX1 supporting the synthesis of each compound.

The claims are amended as follows:

1-22. (canceled)

23. A positive electrode active material comprising a layered structure and a disordered rock-salt structure, wherein the positive electrode material comprises Li and M′ having a Li/M′ ratio z (mol/mol), wherein 1.05≤z≤1.27 and M′ is an element other Li and O.

24. The positive electrode active material according to claim 23, wherein 1.1≤z≤1.27.

25. The positive electrode active material, according to claim 23 represented by formula (I) 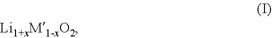
wherein x is in a range of 0<x<0.6,
wherein M′ is selected from the group consisting of Ni, Co, Mn, Q, M″ and a combination thereof, wherein Q is an element other than Li, O, Ni, Co, Mn and M″ and wherein M″ is selected from the group consisting of Ti, Zr, Hf, V, Nb, Ta, Cr, Mo, W, Te, Sb and a combination thereof.

26. The positive electrode active material, according to claim 23, wherein M″ is Cr, W, Mo, or a combination thereof.

27. The positive electrode active material, according to claim 24, wherein x is in a range of 0.01≤x≤0.12.

28. The positive electrode active material, according to claim 24, wherein Q is selected from the group consisting of Al, B, Ba, Ca, Fe, Mg, S, Si, Sr, Y, Zn, and combinations thereof.

29. The positive electrode active material, according to claim 24, wherein Q is in a content e, wherein 0.0≤e≤2.0 mol %, relative to M′.

30. The positive electrode active material, according to claim 23, represented by formula (II) 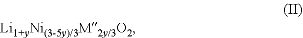
wherein 0<y≤0.6, relative to the total amount of Li, Ni, and M″.

31. The positive electrode active material, according to claim 30, wherein y is in a range of 0.01≤y≤0.12, relative to the total amount of Li, Ni and M″.

32. The positive electrode active material, according to claim 31 represented by formula (II)h 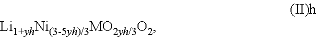
wherein yh is in a range of 0.01≤yh≤0.12, relative to the total amount of Li, Ni, and Mo.

33. The positive electrode active material, according to claim 23, wherein the layered structure comprises LiNiO₂.

34. The positive electrode active material, according to claim 23, wherein the disordered rock-salt structure comprises Li₄MoO₅.

35. The positive electrode active material, according to claim 23, wherein the layered structure has peaks around 2q=17.5-20.0° and 2q=43.5-45.5°, as determined via X-ray diffraction.

36. The positive electrode active material, according to claim 23, wherein the disordered rock-salt structure has peaks around 2q=29.5-30.5° and 2θ=34.5-35.5°, as determined by X-ray diffraction.

37. The positive electrode active material, according to claim 23, wherein the ⁷Li signal of the layered structure is determined between 600 and 750 ppm, as determined via ⁷Li NMR.

38. The positive electrode active material, according to claim 23, wherein the layered structure comprises between 20.0 and 70.0 mol % ⁷Li, relative to the total amount of Li of the positive electrode active material, as determined via ⁷Li NMR.

39. The positive electrode active material, according to claim 23, wherein the ⁷Li signal of the disordered rock-salt structure is determined between 100 and 100 ppm, as determined via ⁷Li NMR.

40. The positive electrode active material, according to claim 23, wherein the layered structure comprises between 5.0 and 50.0 mol % ⁷Li, relative to the total amount of Li of the positive electrode active material, as determined via NMR.

41. A method for manufacturing a positive electrode active material, wherein said method comprises the consecutive steps of:
Step 1) dissolving salts of M′ with stoichiometric molar ratio into an alcohol or water and stirring while heating to obtain a mixture, wherein M′ comprises Ni and
M″ and wherein M″ is selected from the group consisting of Ti, Zr, Hf, V, Nb, Ta, Cr, Mo, W, Te, Sb and combinations thereof;
Step 2) drying said mixture at a temperature in a range of 100 to 150° C.; and
Step 3) heating the dried material at a temperature in a range of 700 to 800° C.

42. A battery comprising the positive electrode active material according to claim 23.
